(19) United States
(12) Patent Application Publication
(10) Pub. No.: US 2012/0269572 A1
(43) Pub. Date: Oct. 25, 2012

(54) FRAMING KIT AND FRAMING

(75) Inventor: Torsten Runge, Straubing (DE)

(73) Assignee: KRONES AG, Neutraubling (DE)

(21) Appl. No.: 13/449,353

(22) Filed: Apr. 18, 2012

(30) Foreign Application Priority Data
Apr. 20, 2011 (DE) 10 2011 007 789.8

(51) Int. Cl. F16B 1/00; F16B 11/00

(52) U.S. Cl. 403/272; 403/270; 403/361

(57) ABSTRACT

A kit for preparing a two-dimensional or a three-dimensional framing for a plant pre-assembly includes a plurality of metallic prefabricated standard segments. Each of the standard segments has a hollow or solid profile section and plug-in socket system components such that the standard segments are connectable to each other, directly or indirectly and in a bearable manner via the plug-in socket system components, by at least one of screwing, soldering and welding to prepare or adapt the framing to a pre-assembly requirement of a plant or a component of the plant.

### CROSS-REFERENCE TO PRIOR APPLICATION

Priority is claimed to German Patent Application No. DE 10 2011 007 789.8, filed on Apr. 20, 2011, the entire disclosure of which is hereby incorporated by reference herein.

### FIELD

The invention relates to a kit for preparing two- or three-dimensional framings for plant pre-assembly, in particular of container treatment plant components, and a framing.

### BACKGROUND

In general mechanical engineering, and mainly in plant engineering, especially in the construction of container treatment plants, machine components and plant components are partially mounted onto framings already in the works as they must have certain spatial positions in the plant. For this, it is possible to completely pre-design and fabricate a framing required for a plant design with the disadvantage that with changed spatial positions of plant components in another plant design, a new framing must be pre-designed and constructed in each case. Only in standard plant designs can pre-designed framings of which several ones are constructed be used universally. Each special design, however, requires a customized framing. A disadvantage of this concept is not only the high amount of structural and constructional efforts, but also the fact that some of the framings need an inappropriately large floor space or inappropriately large available space which is unsuitable and actually superfluous in the later plant.

### SUMMARY

In an embodiment, the present invention provides a kit for preparing a two-dimensional or a three-dimensional framing for a plant pre-assembly. The kit includes a plurality of metallic prefabricated standard segments. Each of the standard segments has a hollow or solid profile section and plug-in socket system components such that the standard segments are connectable to each other, directly or indirectly and in a bearable manner via the plug-in socket system components, by at least one of screwing, soldering and welding to prepare or adapt the framing to a pre-assembly requirement of a plant or a component of the plant.

### BRIEF DESCRIPTION OF THE DRAWINGS

The present invention will be described in even greater detail below based on the exemplary figures. The invention is not limited to the exemplary embodiments. Features described and/or represented in the various figures can be used alone or combined in embodiments of the present invention. Other features and advantages of various embodiments of the present invention will become apparent by reading the following detailed description with reference to the attached drawings which illustrate the following:

FIG. 1 shows various standard segment types of a kit for preparing framings;

FIG. 2 shows a part of a framing prepared to be adaptable in a pre-assembly of at least one plant component;

FIG. 3 shows another embodiment of the framing and at least one plant component in the pre-assembly; and

FIG. 4 shows another embodiment of an adaptable framing in the pre-assembly of a plant component.

### DETAILED DESCRIPTION

In an embodiment, the invention provides a kit for the universal modular preparation of framings for plant pre-assembly, and a framing which flexibly corresponds to the respective plant pre-assembly requirement. Therefore, according to embodiments of the invention, framings for special designs of plants in a universal and modular manner are provided, such that the framings only occupy the space, or the floor space, currently actually required in each case.

By the framing that can be prepared to be adaptable, standardized pre-designed and prefabricated standard segments can be used for customized framing construction without pre-designing and fabricating a framing completely separately. Since the respective framing can be individually adapted corresponding to the respective pre-assembly requirement, only the actually required space or the actually required floor space is occupied, so that the framing is always adapted to the respective plant design. An essential advantage of this concept is that in special designs of plants, no pre-construction or prefabrication of customized framings is required, but that one can resort to the standard segments, or the framing which then has to be prepared from the standard segments is prepared in a fitting manner or as it is required only in the course of pre-assembly. The standard segments are prefabricated with the provided plug-in socket system components in a sufficient quantity and with sufficient compatibility and bearing capacity, and as adaptable framing, they are integrated in the respective componentized construction or plant component array. Here, several identical standard segments also usable for special designs are optionally used for each plant. Each assembly finally has an adapted framing and can also be modularly connected to a framing of a corresponding assembly via its framing directly or indirectly, indirectly e.g. via standardized connection segments. Only in the course of pre-assembly, the prefabricated standard segments are welded, soldered or screwed to ensure the required stability and bearing capacity of the framing.

In one suitable embodiment of the kit, at least one standard segment type is a straight round or polygonal profile section with a protruding plug-in socket system component at one end, and a recessed plug-in socket system component in the other end. The plug-in socket system components can be round or polygonal and each fit together in pairs.

Suitably, at least one further standard segment type is a straight round or polygonal profile section with a protruding plug-in socket system component at one end and a recessed plug-in socket system component in the other end, and at least one laterally protruding pre-assembly base and a pre-assembly abutment essentially oriented vertically to the axis of the straight hollow or solid profile section on the pre-assembly base, a hollow passage being defined between the pre-assembly base and the pre-assembly abutment. This segment type modularly matches other ones and allows to stably fix plant components.

Furthermore, another standard segment type suitably is a 90° hollow or solid profile section with an angled or rounded extension and a protruding plug-in socket system component at one end and a recessed plug-in socket system component at the other end. This segment type is e.g. used for connection and/or space creation tasks and can also bear plant components.

Furthermore, the kit can suitably comprise at least one further standard segment type for the indirect connection of other identical or not identical standard segment types which can be a standard connection segment with corresponding protruding and recessed plug-in socket system components. Here, at the segment type, several pairs of such protruding and recessed plug-in socket system components can be provided, optionally orthogonally in two or even three intersecting directions to create a two- or three-dimensional coupling module.

Within the kit, standard segment types can be prefabricated of a hollow or solid profile with different diameters (round profiles or tubes) or widths (polygonal profiles or special section tubes).

To be able to establish the respective connection in the adaptable framing or in the modular connection of two framings each even if standard segment type ends of different dimensions are joined, at least the respective standard connection segment can be suitably embodied like an adapter in adaptation to different diameters or widths to be connected.

During the prefabrication of the standard segment types, threaded bores and/or weld seam bevels can be already prefabricated for the connection to facilitate the preparation of the respective framing.

Furthermore, an at least exterior surface treatment of the different standard segment types can be suitable. A coating, a coat of lacquer or other measures ensure a predetermined corrosion resistance and/or desirable hygienic demands in storage as well as in the later operation of the plant.

The respective framing prepared to be adaptable for the pre-assembly of plant components individually or in groups is not pre-designed and prefabricated, but is prepared to be adaptable corresponding to the respective plant pre-assembly requirement only in the course of pre-assembly, wherein universally fitting standard segment types of a kit are used. Thus, framings of special designs of plants can also be easily prepared from them. In a plant, each component or group of components can be pre-assembled at a separate adaptable framing. This framing can then be modularly fixed to any other framing of another plant component group or plant component, so that not only each framing can be prepared to be adaptable, but the complete frame structure of a plant is assembled modularly in steps corresponding to the requirements, resulting in greater flexibility in case of special designs of plants and in a better utilization of space.

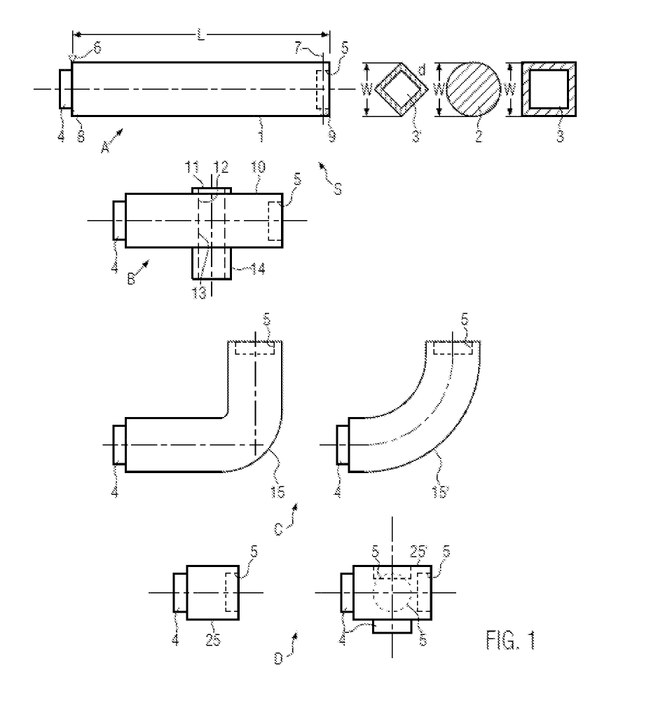

FIG. 1 shows several preferred standard segment types A, B, C and D of a kit S for preparing an adaptable framing R (FIGS. 2 to 4) in the pre-assembly of plants or plant components K1, K2, K3, in particular container treatment plant components. The standard segment types A to D are prefabricated and are modularly combined and connected for preparing a respective framing R corresponding to the plant pre-assembly requirement according to the respective requirement to form a bearable framing R.

A first standard segment type A is a straight hollow or solid profile section 1 of a predetermined length L (diameter d, for example with a solid round profile 2 of steel or light metal, width w e.g. with a hollow polygonal profile 3, 3′). Of course, the round profile 2 can be hollow (a tube), or the polygonal profile 3, 3′ can be a solid profile, e.g. a square or hexagon profile. The polygonal profile 3′ can be installed/oriented in the framing R, as in FIG. 1, rotated about the profile axis, e.g. about 45°. This would be advantageous under hygienic aspects as liquids can better flow off.

At the standard segment type A, a protruding plug-in socket system component 4 is provided at one end, for example a largely circular cylindrical or polygonal projection, or a projection of another profile, with a smaller outer diameter or a smaller outer width than that of the solid or hollow profile section 1. In the opposite end, a recessed plug-in socket system component 5 is preformed which is either a correspondingly profiled or round indentation or is formed by the inner diameter or the inner cross-section of a hollow profile itself. The plug-in socket system components 4, 5 are e.g. coaxial and fit together. Polygonal plug-in socket system components 4, 5 can determine, e.g. with polygonal profiles 3, 3′ (FIG. 1), a certain position rotated about the longitudinal axis of the respective standard segment type A, B, C, D in the preparation of the framing R (e.g. for hygienic aspects).

In the preparation of an adaptable framing R (FIGS. 2 to 4), the connection of standard segment types A is accomplished using the plug-in socket system components 4, 5 and additionally by screwing, soldering or welding. Welding is indicated at 6, whereas screwing is indicated at 7. For this, the respective standard segment type A (to D) can be already prefabricated with at least one weld seam bevel 8 and/or threaded bores 9.

A further standard segment type B is a straight round or solid profile section 10, optionally of a length different to that of the standard segment type A, but also with protruding and recessed plug-in socket system components 4, 5. In addition, the standard segment type B comprises at least one lateral pre-assembly base 14 which essentially extends perpendicularly to the axis of the solid or hollow profile section 10 and to which the opening of a hollow channel 13, or even a physical pre-assembly abutment 11, such as a plate, a base, an indentation or the like, is diametrically oriented as an abutment 12, quasi as integrated pre-assembly support.

In non-depicted alternative embodiments of the standard segment type B, several bases 14 and abutments 12, 11 can be provided distributed in the longitudinal direction and/or in different directions. The standard segment type B can match e.g. the standard segment type A (and C, D) within the kit S.

Another standard segment type C of the kit S is either a 90° solid or hollow profile section 15, 15′ with an angled extension or a rounded extension and the attached protruding and recessed plug-in socket system components 4, 5.

A further standard segment type D could belong to the kit S as standard connection segment. This can be a straight hollow or solid profile section 25 of a relatively short length with the protruding and recessed plug-in socket system components 4, 5 which are oriented coaxially to each other, or with several pairs of projecting and recessed plug-in socket system components 4, 5. These pairs can be provided in several differently oriented axes, optionally in three orthogonally oriented axes which intersect each other or can be offset to each other.

The material of the standard segment types A to D prefabricated in a sufficient quantity in the kit S is suitably a metal, such as steel or a light metal or a light metal alloy, optionally with an interior and/or exterior surface treatment.

In FIG. 2, in the pre-assembly of a plant component K1, the plant component K1 is fixed on a transverse member 16 with a base part 17 which is fixed on standard segment types A of the frame R adapted during pre-assembly, for example with clips 18.

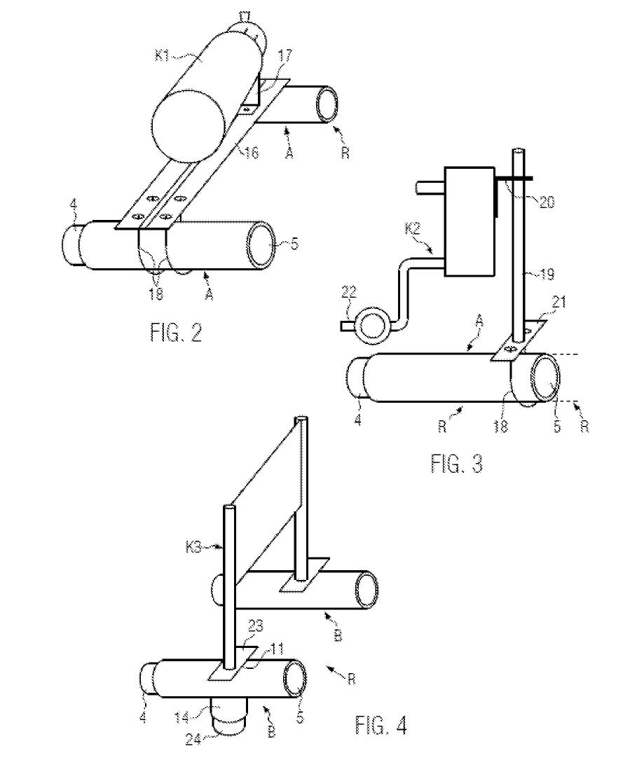

In FIG. 3, another plant component K2 is retained on the one hand via a console 20 at a support 19 which is pre-assembled upright with a bearing 21 and a clip 18, while at the other side, a support 22 is laterally fixed at the standard segment type A of the framing R. The framing R in FIG. 3 can be modularly connected with a further framing R, indicated in a dashed line, of another plant component, for example using the plug-in socket system components 4, 5, or indirectly via the standard segment types B, C and/or D.

In FIG. 4, another plant component K3 is represented which is pre-assembled with base parts 23 on the abutments 11 of two standard segment types B of FIG. 1 of the kit S. Here, pins 24 are suitably used which are inserted through the hollow channels 13 shown in FIG. 1 and supported at the framing R by means of the pre-assembly base 14 and the respective abutment 11, 12.

What is claimed is:

1. A kit for preparing a two-dimensional or a three-dimensional framing for a plant pre-assembly, the kit comprising:
a plurality of metallic prefabricated standard segments, each of the standard segments having a hollow or solid profile section and plug-in socket system components such that the standard segments are connectable to each other, directly or indirectly and in a bearable manner via the plug-in socket system components, by at least one of screwing, soldering and welding to prepare or adapt the framing to a pre-assembly requirement of a plant or a component of the plant.

2. The kit according to claim 1, wherein the pre-assembly requirement is a pre-assembly requirement of a component of a container treatment plant.

3. The kit according to claim 1, wherein the plurality of standard segments include at least one standard segment of a standard segment type having a straight round or polygonal profile section with a protruding plug-in socket system component at a first end and a recessed plug-in socket system component at a second end.

4. The kit according to claim 1, wherein the plurality of standard segments include at least one standard segment of a standard segment type having a straight round or polygonal profile section with a protruding plug-in socket system component at a first end and a recessed plug-in socket system component at a second end, at least one laterally projecting pre-assembly base and a pre-assembly abutment oriented toward the pre-assembly base essentially perpendicularly to a longitudinal axis of the straight round or polygonal profile section, a hollow channel being disposed in the profile section through the pre-assembly abutment.

5. The kit according to claim 1, wherein the plurality of standard segments include at least one standard segment of a standard segment type having a 90° round or polygonal profile section with an angled or round extension with a protruding plug-in socket system component at a first end and a recessed plug-in socket system component at a second end.

6. The kit according to claim 1, wherein the plurality of standard segments include at least one standard segment of a standard segment type connectable to another standard segment type and having a straight round or polygonal profile section with a plurality of pairs of projecting and recessed plug-in socket system components, each of the pairs being disposed along a different axis.

7. The kit according to claim 1, wherein the plurality of standard segments include standard segment types that are prefabricated from hollow, solid round or polygonal profiles of same or different diameters or widths.

8. The kit according to claim 7, wherein the plurality of standard segments include at least one standard segment of a standard segment type configured as an adaptor to indirectly connect at least two other standard segments having different diameters or widths to each other.

9. The kit according to claim 8, wherein the standard segment type configured as the adaptor includes plug-in-socket system components of different diameters or widths that correspond to the different diameters or widths of the at least two other standard segments.

10. The kit according to claim 1, wherein the plurality of standard segments include standard segment types that are prefabricated with at least one of threaded bores and weld seam bevels as the plug-in socket system components.

11. The kit according to claim 1, wherein the plurality of standard segments are surface-treated at least on an outer surface.

12. The kit according to claim 1, wherein the plurality of standard segments include at least one standard segment of a standard segment type having a polygonal profile and disposed rotated with respect to a profile axis of the framing so as to provide an outflow.

13. A framing for the pre-assembly of a plant having components that are pre-assembled individually or in groups, the framing comprising:
a plurality of metallic prefabricated standard segments, each of the standard segments having a hollow or solid profile section and plug-in socket system components such that the standard segments are connectable to each other, directly or indirectly and in a bearable manner via the plug-in socket system components, by at least one of screwing, soldering and welding to prepare or adapt the framing to a pre-assembly requirement of the plant or one of the components of the plant.

14. The framing according to claim 13, wherein the pre-assembly requirement is a pre-assembly requirement of a component of a container treatment plant.

15. The framing according to claim 14, wherein the framing is modularly connectable to another framing for the pre-assembly via the plug-in socket system components.
